(19) United States
(12) Patent Application Publication
(10) Pub. No.: US 2007/0188612 A1
(43) Pub. Date: Aug. 16, 2007

(54) video system for individually selecting and viewing events at a venue

(75) Inventor: Ronald E. Carter, Matthews, NC (US)

Correspondence Address: TILLMAN WRIGHT, PLLC, PO BOX 471581, CHARLOTTE, NC, 28247, US

(73) Assignee: REVOLUTIONARY CONCEPTS, INC., Matthews, NC (US)

(21) Appl. No.: 11/674,666

(22) Filed: Feb. 13, 2007

Related U.S. Application Data
(60) Provisional application No. 60/772,745, filed on Feb. 13, 2006.

(51) Int. Cl. H04N 7/18

(52) U.S. Cl. 348/157; 348/159

(57) ABSTRACT

A digital video system for individually selecting and viewing an event at a venue, comprising: a plurality of video cameras positioned at various locations at a venue, each video camera configured to transmit video therefrom; a plurality of wireless mobile viewing devices at the venue, each configured to, receive input from a user of the wireless mobile viewing device, the input representing a selection of a video camera from the plurality of the video cameras for viewing of video transmitted therefrom, receive video transmitted from the selected video camera, and display to the user of the wireless mobile viewing device the received video taken from the selected video camera. A transmitter is located at the venue and broadcasts the video taken from each video camera for transmission to each of the wireless mobile viewing devices. A communications hub receives and communicates the video to the transmitter at the venue.

### CROSS-REFERENCE TO RELATED APPLICATION

The present application is a U.S. nonprovisional patent application of, and claims priority under 35 U.S.C. § 119(e) to, U.S. provisional patent application Ser. No. 60/772,745, filed Feb. 13, 2006, which provisional patent application is incorporated by reference herein in its entirety.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates a video system that permits users to individually select and view one of many events that may be occurring simultaneously at a venue. Such a system may be utilized, for example, at a sporting event like a race at a speedway, a football game at a stadium, or a basketball game at an arena.

Traditionally, when sporting events are televised, the television coverage provided to the viewers includes only those scenes that a director has determined to be of widest interest to the greater viewing audience. While the coverage may utilize multiple cameras, the images that are disseminated for display on a viewer's television screen at any given time are usually limited to only the video stemming from a single one of the cameras, even though the control booth is receiving video from each of the cameras.

Furthermore, even when cable or satellite coverage is provided to viewers that includes video from two or more different video cameras, such as may be done, for example, by ABC networks or an affiliated entity, such coverage is accomplished utilizing different cable or satellite channels, and such coverage is unavailable to observers at the venue via wireless mobile viewing devices.

Accordingly, a need exists for a video system that provides a viewer at the venue using a mobile wireless viewing device the ability to receive video from a video camera that is selected by the viewer as being of particular interest to that viewer. Such selection of the video to be viewed should be independent of the video selected by any other viewer also using a wireless mobile viewing device at the venue. Each viewer further should have the ability to continue to select video from different cameras located at different locations at the venue, on demand, for switching between the viewing of real time events as they occur at the venue.

The video system also may have a relatively high level of security, such that the video would only be available to selected viewers, such as those having subscribed to the video system and/or rented or purchased particular mobile wireless viewing devices. Alternatively, the video system may be provided for the benefit of the public and thus may be freely accessible.

### SUMMARY OF THE INVENTION

The present invention includes many aspects and features.

In accordance with the a first aspect of the invention, a method for providing multiple viewing opportunities of events at a venue includes simultaneously communicating video taken from each of a plurality of video cameras, positioned at various locations at a venue, for receipt by each of a plurality of wireless mobile viewing devices at the venue. The video is simultaneously communicated such that video taken from each video camera may be selectively received and viewed by each wireless mobile viewing device independently of receipt and viewing of video by any of the other wireless mobile viewing devices.

In features of this aspect, the step of simultaneously communicating video taken from each of the plurality of video cameras positioned at various locations at the venue includes communicating the video taken from each video camera over the Internet and/or a cellular network.

In another feature, the step of simultaneously communicating video taken from each of the plurality of video cameras positioned at various locations at the venue includes simultaneously broadcasting, at the venue, the video taken from each of the plurality of video cameras. The video taken from each video camera may be simultaneously broadcast at the venue from the same transmitter or may be simultaneously broadcast at the venue from respective transmitters each located at a respective video camera.

In another feature, the step of communicating video taken from each video cameras positioned at various locations at the venue includes streaming the video to one or more of the wireless mobile viewing devices at the venue. The method may further include associating video taken from each video camera positioned at various locations at the venue with a unique IP address by which a wireless mobile viewing device may access video taken from such video camera.

In another aspect of the invention, a method for providing multiple viewing opportunities of events at a venue includes simultaneously broadcasting video taken from each of a plurality of video cameras, positioned at various locations at a venue, for receipt by each of a plurality of wireless mobile viewing devices at the venue, such that video taken from each video camera may be selectively received and viewed by each wireless mobile viewing device independently of receipt and viewing of video by any of the other wireless mobile viewing devices.

In another feature of this aspect, the video taken from each video camera may be simultaneously broadcast at the venue from a different transmitter each located at a respective video camera or may be unilaterally broadcast from the same transmitter located at the venue.

In another feature, the broadcasting may include unilaterally broadcasting the video taken from each of the plurality of video cameras positioned at various locations at the venue without regard to: whether any wireless mobile viewing device is within a transmission range of the broadcast; without regard to whether any wireless mobile viewing device has been detected within the transmission range of the broadcast; whether, for each respective video, the video has been selected for viewing by any wireless mobile viewing device; and/or whether, for each respective video, any wireless mobile viewing device receives the video.

In another feature, the method further includes receiving, at a communications hub, the video taken from each of the plurality of video cameras positioned at various locations at the venue; and communicating the received video to a transmitter for broadcasting to wireless mobile viewing devices at the venue. The communications hub may be a vehicle and the video cameras may be wireless video cameras.

In still yet other features, the broadcast to each of the wireless mobile viewing devices is encrypted; and the video cameras are controlled remotely from a central location, wherein the remote control of a video camera includes adjusting a viewing angle, magnification, or brightness of the video camera.

In another aspect of the invention, a digital video system for individually selecting and viewing an event at a venue includes: a plurality of video cameras positioned at various locations at a venue, each video camera configured to transmit video therefrom; a plurality of wireless mobile viewing devices at the venue. Each wireless mobile viewing device is configured to receive input from a user thereof, the input representing a selection of a video camera from the plurality of the video cameras for viewing of video transmitted therefrom; to receive video transmitted from the selected video camera; and to display to the user of the wireless mobile viewing device the received video taken from the selected video camera.

In a feature of this aspect, the plurality of video cameras include a plurality of wireless video cameras.

In another feature, each of the wireless mobile viewing devices includes a handheld portable device for carrying by an observer located in seating area of the venue for viewing a main event of the venue.

In another feature, the venue comprises a speedway, a sports stadium, a sports arena, a concert hall or theater, or a circus.

In another feature, the system further includes a local transmitter located at the venue and configured to broadcast the video taken from each video camera for wireless transmission to each of the plurality of the wireless mobile viewing devices. At least one of the broadcasts to each of the wireless mobile viewing devices is encrypted, and each wireless mobile viewing device is configured to decrypt the encrypted broadcast. The video taken from each video camera is simultaneously transmitted by the local transmitter in separate respective broadcasts.

The system also may include a communications hub configured to receive the video wirelessly transmitted from each of the video cameras, and to communicate the received video to the local transmitter for broadcast to the wireless mobile viewing devices. The communications hub and the local transmitter may be disposed in electrical communication via the Internet, via wireless communications, and/or via wired communications.

In another feature, each wireless mobile viewing device includes a wireless receiver and does not include a wireless transmitter. In an alternative feature, each wireless mobile viewing device may include a transceiver and each wireless mobile viewing device may be configured to register with a wireless network before receiving the video transmitted from the selected video camera, such as with a cellular network or a WiFi, WiMax, 802.11(b) compatible, or Bluetooth network.

In still yet other features, a wireless mobile viewing device may include a mobile phone, smartphone, personal digital assistant (PDA), pocket personal computer, or other kind of handheld and portable consumer electronic device.

In other features, one or more wireless cameras are located on racecars; on helmets of a football player; and/or are mounted on physical structures at a venue.

In addition to the aforementioned aspects and features of the present invention, it should be noted that the present invention further encompasses the various possible combinations of such aspects and features.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is a schematic representation of a digital video system in accordance with a preferred embodiment of the present invention, wherein the digital video system is utilized at a motor speedway;

FIG. 2 is a perspective view of an exemplary racecar having wireless cameras mounted thereon;

FIG. 3 is a schematic illustration of a wireless network utilized in the digital video system of FIG. 1;

FIG. 4 is a schematic illustration of a website provide in association with the digital video system of FIG. 1; and

FIG. 5 is a schematic illustration of a digital video system in accordance with another preferred embodiment of the present invention, wherein the digital video system is utilized at a football game.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its applications, or uses.

In accordance with one or more preferred embodiments of the present invention, a system 10 for selectively viewing main event and sub-events at a venue includes a plurality of video cameras and a plurality of wireless mobile viewing devices, all arranged in, around or adjacent a particular venue. The venue may be a sporting venue, an entertainment venue, an information-providing venue, a secured venue, or any other venue at which a plurality of users are or may be interested in being able to display, in real time, selected video being generated at the venue. The wireless mobile viewing devices are utilized by viewers of various types to select a particular video of the plurality of videos originating from the various video cameras. The viewer types may vary according to the type of venue at which the system 10 is implemented, but it is anticipated that a primary class of viewers at many venues will be spectators of the type found at sporting events, musical, theatrical and other entertainment events, and the like.

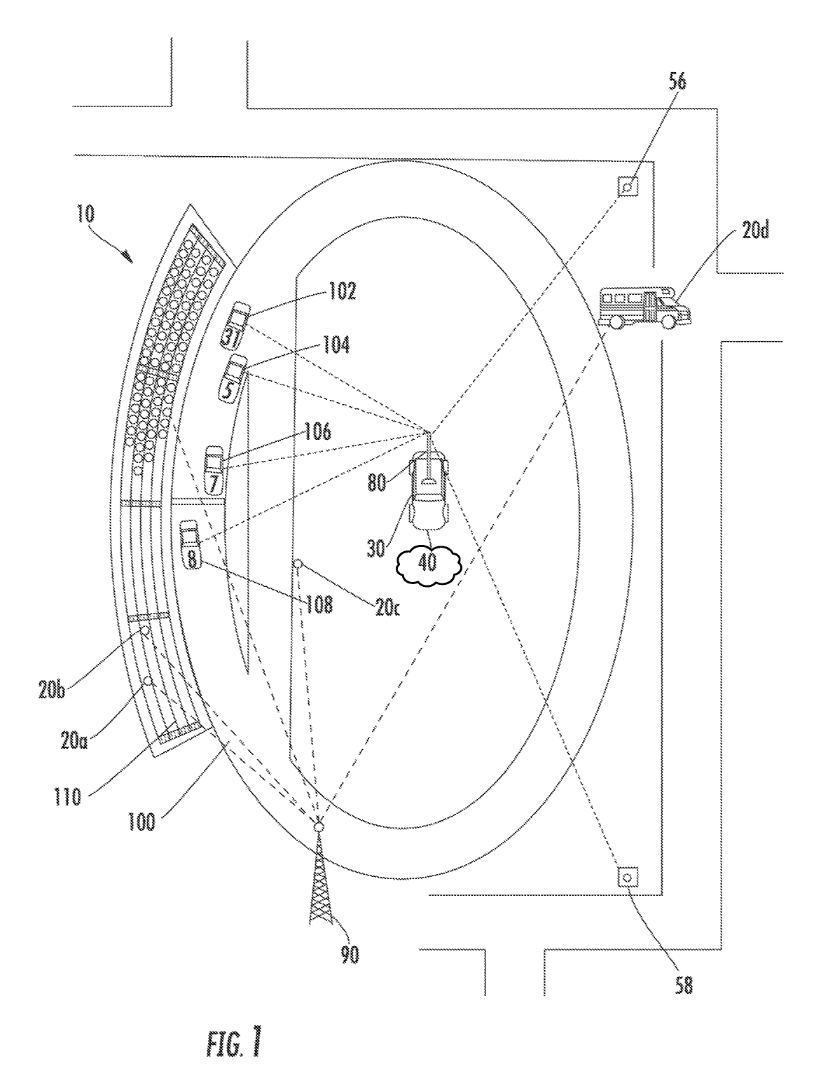

FIG. 1 is a schematic representation of a first exemplary implementation of a system 10 of the present invention. In this implementation, the venue is a motor speedway, which includes a racetrack 100 and a grandstand 110. As shown in FIG. 1, viewers are equipped with wireless mobile viewing devices for viewing, in real time, the events transpiring at the speedway, including the main event (i.e., race cars circling the racetrack 100) and sub-events that occur on or adjacent the racetrack 100 (e.g., activities taking place in the pits) as well as sub-events that occur in other areas of or around the speedway (e.g., activities taking place in garages located at some distance from the track itself, or taking place in, beneath or behind the grandstand 110). In FIG. 1, the wireless mobile viewing devices of the system 10 are represented, for example, by wireless mobile viewing devices 20a,20b,20c,20d. Some wireless mobile viewing devices 20a,20b may be utilized, for example, by fans in the grandstand 110; another wireless mobile viewing device 20c may be utilized, for example, by a member of a racing team; and still another wireless mobile viewing device 20d may be utilized, for example, by speedway personnel located at the speedway. Notably, the wireless mobile viewing devices 20a,20b,20c,20d need not necessarily be located in the immediate vicinity of the racetrack 100; they may, for example, be located at some distance from the racetrack 100 itself.

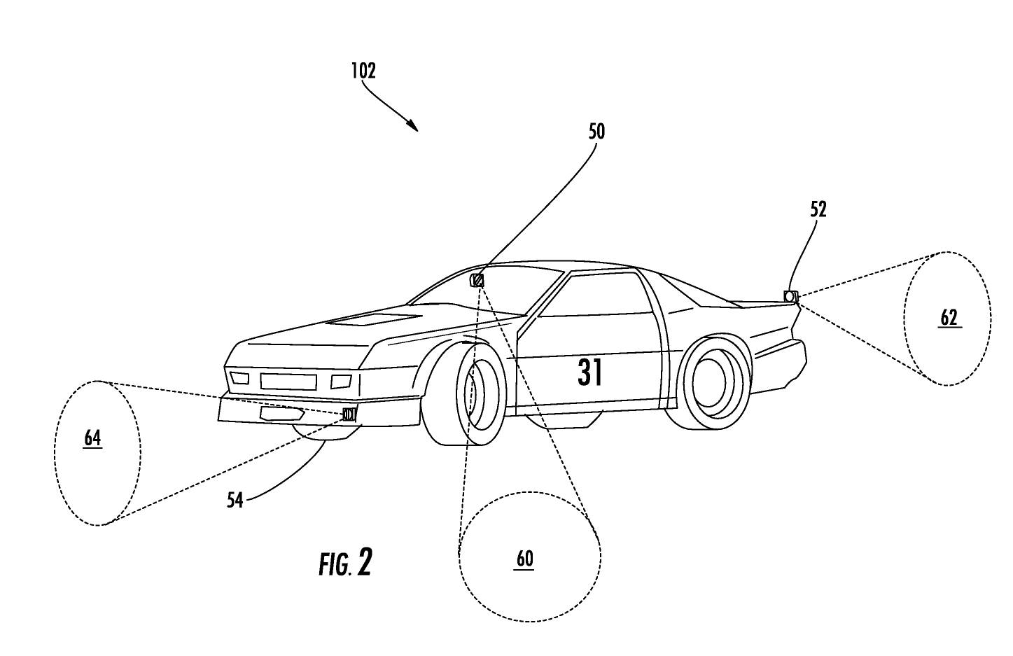

The video cameras, which may include both wired and wireless video cameras, may likewise be arranged in various locations in, around or adjacent the speedway. As will be evident to the Ordinary Artisan, the particular arrangement of video cameras will be dependent upon the type and configuration of the venue in which they are arranged. For example, as shown in FIGS. 1 and 2, wireless video cameras may be carried by racecars, while wired or wireless cameras may be appropriately distributed around the speedway for monitoring and surveillance functionality. In particular, four cars 102,104,106,108 are shown competing in a race in FIG. 1. Each of the four cars is generally equivalent to, and represented by, the exemplary racecar 102 of FIG. 2, which has at least three wireless video cameras 50,52,54 mounted thereon. Camera 50 is mounted inside racecar 102 and faces generally toward the left front of the car 102. An exemplary angle of view of camera 50 is illustrated by the dashed line cone 60. Camera 54 is mounted to face forwardly, as illustrated by the dashed line cone 64, and camera 52 is mounted to face rearwardly as illustrated by the dashed line cone 62. The car 102 includes an air foil, which has been omitted from FIG. 2 for clarity in describing camera 52. Meanwhile, at least two additional video cameras 56,58 are located at corners of the premises for monitoring incoming and outgoing traffic.

In many applications of the present invention, the same event (which may be the main event or a sub-event) may be covered by more than one video camera. For example, in the speedway implementation of FIG. 1, a stationary video camera may be manually or automatically controlled to capture images of the lead racecar 108 in a race as it moves around the racetrack 100, while a wireless video camera 54 in a racecar 106 near the lead racecar 108 captures images of the lead racecar 108 from a different vantage point.

In operation, each of the wireless video cameras 50,52,54,56,58 transmits video, and each of the wireless mobile devices 20a,20b,20c,20d is capable of receiving and displaying video generated by any of the wireless video cameras 50,52,54,56,58. Each of the wireless video cameras 50,52,54,56,58 optionally also transmits audio in conjunction with the video, and each of the wireless mobile devices 20a,20b,20c,20d is preferably correspondingly capable of receiving and presenting such audio in conjunction with the display of the video taken from the wireless video cameras 50,52,54,56,58.

As will be appreciated, a spectator in the grandstand 110 may, using one of the wireless mobile viewing devices 20a,20b, select and view, as it is received, the video taken from any of the wireless video cameras 50,52,54,56,58, with such selection made according to his or her own preferences. Further, such selection, and the viewing of the video so selected, may be carried out independently from the selections made by any other spectator (or viewer of any other type) as to what to view on their own respective wireless mobile viewing device. Thus, any interested observer may choose to view, using his respective wireless mobile viewing devices, any desired video as selected from the available video of the main event or any sub-event, wherein such video is all being generated at the same time in and around the same venue, giving the observer unprecedented viewing opportunities.

The communication of the video taken from the wireless video cameras 50,52,54,56,58 and transmitted to the wireless mobile device 20a,20b,20c,20d may be accomplished through various different system architectures. Furthermore, while one or more such system architectures forms an aspect of the invention, the broader scope of the invention is intended to be generic to the particular architecture that is employed.

In one particular system architecture, the video is taken from the video cameras and is received at a communications hub 30, which is represented in FIG. 1 by a mobile communications truck. In many, but not necessarily all, applications the communications hub is centrally located relative to the venue, the video cameras, and/or the mobile wireless viewing devices present in the venue. In order to communicate at least with wireless video cameras, the communications hub preferably includes one or more wireless receivers or transceivers for wirelessly receiving video signals from the wireless video cameras and, in at least some embodiments, wirelessly controlling the wireless video cameras. When such a wireless receiver or transceiver is utilized, the communications hub 30 may be further equipped with an antenna 80 and/or appropriate amplification to improve reception of the video-carrying wireless signals. Reception may be further improved through the use of repeaters (not illustrated) stationed in appropriate locations around the venue.

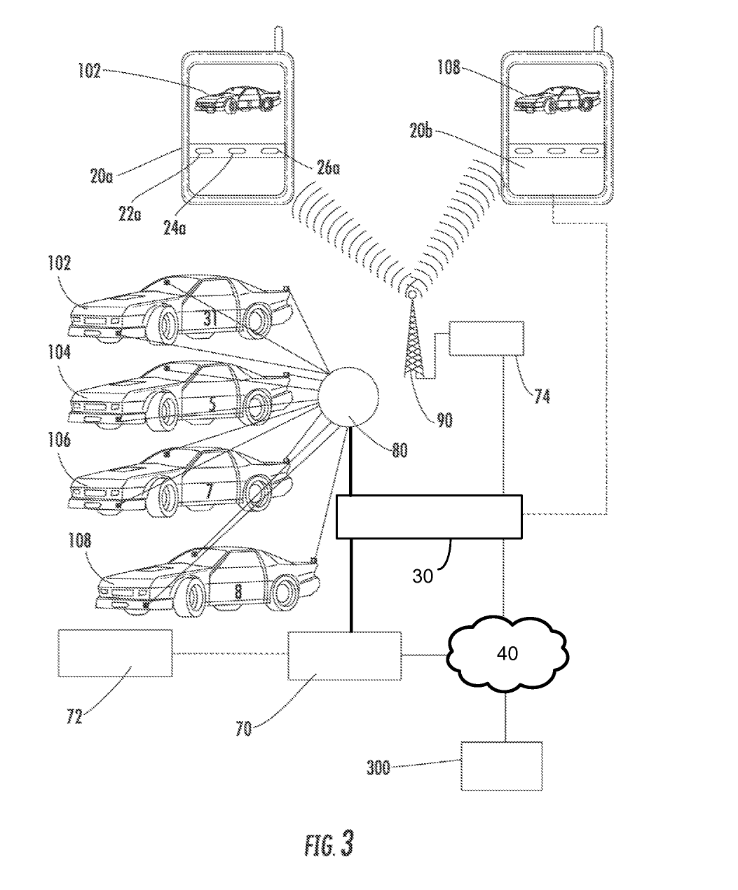

The communications hub 30 may serve to centralize at least some video distribution functions. A particularly useful function that may be performed centrally by the communications hub 30 is the centralized and controlled distribution of the video from the various video cameras. Several exemplary distribution technologies are schematically illustrated, at least partially, in the various drawings, but it will be apparent to the Ordinary Artisan that other distribution technologies may likewise be utilized in at least some embodiments of the present invention. Referring particularly to FIGS. 1 and 3, the communications hub 30 may be communicatively connected to a variety of distribution technologies, including, but not limited to, a transmitter 74 for broadcast from a communications antenna or tower 90, the Internet 40 (the connection from the communications hub 30 to the Internet 40 also being shown in FIG. 1), a wireless modem or other wireless communication device or network element 70 for direct transmission to a personal computing device 72, or a WiFi, WiMax, 802.11(b) compatible, or Bluetooth network connection (shown in FIG. 3 as a dotted line extending from the right side of the communications hub 30 to the mobile wireless viewing device bearing reference numeral 20b) to one or more mobile wireless viewing devices. With particular regard to the transmitter 74 and communications antenna or tower 90, it will be recognized that such an arrangement may be used in conjunction with conventional cellular technology, another conventional technology, or a proprietary technology. With particular regard to distribution via the Internet 40, it will be recognized that the videos may be distributed via one or more websites using conventional streaming or other video technologies.

Another useful function that may be performed centrally by the communications hub is the scrambling or encryption of the video from the respective video cameras in order to limit access to the unscrambled or decrypted video to only authorized viewers. This may be useful in at least some commercial embodiments in which users are required to pay any of a variety of fees in order to be able to receive and view the video. Of course, if desired, this function may also or alternatively be performed at any of the video cameras. When encryption or the like is utilized, each mobile wireless viewing device is preferably equipped with the appropriate decryption technology and any keys or the like necessary to perform such decryption or unscrambling.

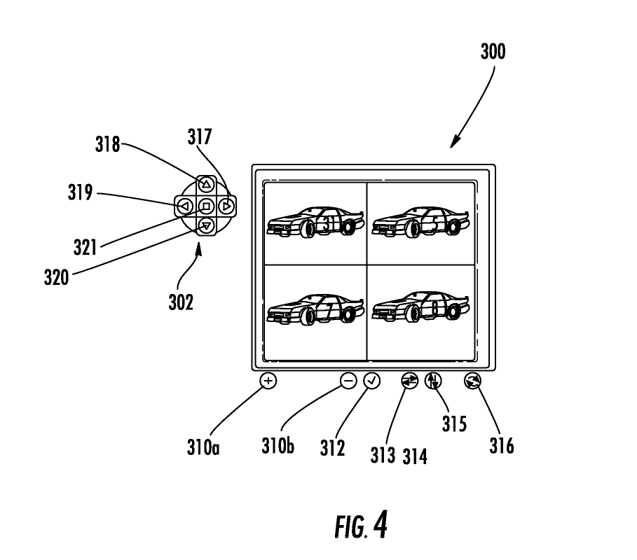

FIG. 4 is a schematic illustration of a website 300 or other display provided for viewing by a spectator or other user in association with the system 10 as implemented in FIG. 1. As illustrated in FIG. 4, in at least some embodiments, multiple videos may be presented in a single display. In the example shown in FIG. 4, videos of four different racecars, each generated simultaneously by a different video camera, may be presented together in the single display.

FIG. 4 also illustrates the use, in at least some embodiments, of one or more user interfaces for controlling the operation of a video camera itself. In particular, it is contemplated that the system 10 may provide the ability to remotely manipulate at least some of the video cameras in one or more ways, such as the camera's position, its brightness adjustment, its ability to pan, or the like. In FIG. 4, the interface is shown to be implemented in a web-based context, but it will be apparent that corresponding controls could likewise be provided in conjunction with other types of graphical user interfaces and on any wireless mobile viewing device. In the interface of FIG. 4, the cross-shaped icon 302 has a left arrow 319 for turning the camera left, a right arrow 317 for turning the camera right, an up arrow 318 for turning the camera up, a down arrow 320 for turning the camera down, and a center button 321 that returns the camera to a central default position. Also provided is an icon 310a or button for increasing the brightness when the light is low, and an icon 310b or button for decreasing the brightness when the light is high. A further icon 312 or button may set the brightness to the default position, and a still further icon 316 or button is a reset button that returns all parameters to the factory settings. The video camera may be set to automatically pan back and forth when icon or button 313 is clicked or pressed, and pans up and down when icon or button 315 is clicked or pressed. Panning may be stopped, for example, by re-clicking the pan icons. Additional controls can be added as appropriate.

It is contemplated that the controls may be enabled or disabled on an as needed basis or an as available basis to avoid undesirable movement of the cameras. For example, when there are multiple viewers, each viewer would have his individual preference on what to view. Difficulties would arise in determining which user is to be given control; depending on the implementation, the camera would be constantly moved, which would be disconcerting to all of the viewers except to the viewer controlling the camera, or in such situations as the illustrated speedway/racecar implementation, a large amount of camera movement would be undesirable because the car is moving, and the combination of moving cameras and a moving car would be confusing and possibly disorienting. In one solution to these problems, the system 10 may provide “averaged” control based on the collective input of all the users. In another solution to these problems, users may be selected, according to some priority arrangement, to control the video camera providing their selected video for a controlled period of time. The priority arrangement may be based, for example, on the order in which users queue for control of the video camera, or on each user's willingness to pay a fee for the privilege of controlling the video camera.

In at least some embodiments, the viewers have no control over the operation of one or more of the video cameras, but a human director or other control booth personnel is provided with various controls which may be of conventional type and operation. In this regard, particular videos made available to wireless mobile viewing devices as viewing options may optionally be interspersed with other videos. For example, one video provided as an option to viewers may, under the control of a director, be arranged to always reflect the view from the wireless video camera in the lead racecar, which, of course, is likely to change from time to time during the course of a race.

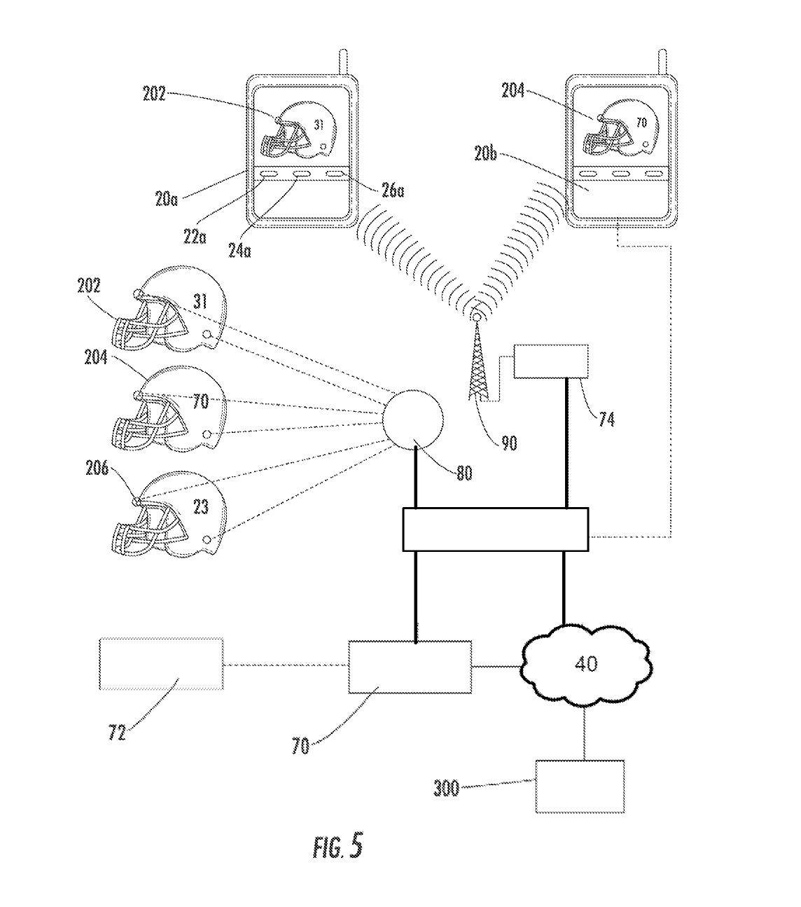

FIG. 5 is a schematic representation of a second exemplary implementation of a system 10 of the present invention. In this implementation, the venue is a football stadium (not shown), and wireless video cameras are placed in or on the helmets of football players, thereby providing viewers with the opportunity to view events of a football game from the perspective of individual football players. At least two cameras are shown on helmets 202,204,206. Further, two wireless mobile viewing devices 20a,20b are shown. As shown on the a spectator may be able to choose between video showing different players (as representatively shown on the respective displays of the two wireless mobile viewing devices 20a,20b) or video from the perspective of the respective players (not shown).

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A digital video system for individually selecting and viewing events at a venue, comprising:
(a) a plurality of video cameras positioned at various locations at a venue, each video camera configured to transmit video therefrom; and
(b) a plurality of wireless mobile viewing devices at the venue, each configured to,
(i) receive input from a user of the wireless mobile viewing device, the input representing a selection of a video camera from the plurality of the video cameras for viewing of video transmitted therefrom,
(ii) receive video transmitted from the selected video camera, and
(iii) display to the user of the wireless mobile viewing device the received video taken from the selected video camera.

2. The system of claim 1, wherein the plurality of video cameras include a plurality of wireless video cameras.

3. The system of claim 1, wherein each of the wireless mobile viewing devices comprises a handheld portable device for carrying by an observer located in seating area of the venue for viewing a main event of the venue.

4. The system of claim 1, wherein the venue comprises a speedway, a sports stadium, a sports arena, a concert hall or theater, or a circus.

5. The system of claim 1, further comprising a local transmitter located at the venue and configured to broadcast the video taken from each video camera for wireless transmission to each of the plurality of the wireless mobile viewing devices.

6. The system of claim 5, wherein at least one of the broadcasts to each of the wireless mobile viewing devices is encrypted, and wherein each wireless mobile viewing device is configured to decrypt the encrypted broadcast.

7. The system of claim 5, wherein the video taken from each video camera is transmitted by the local transmitter in separate respective broadcasts.

8. The system of claim 5, further comprising a communications hub configured to,
(a) receive the video wirelessly transmitted from each of the video cameras, and
(b) communicate the received video to the local transmitter for broadcast to the wireless mobile viewing devices.

9. The system of claim 8, wherein the communications hub and the local transmitter are disposed in electrical communication via the Internet.

10. The system of claim 8, wherein the communications hub and the local transmitter are disposed in electrical communication via wireless communications.

11. The system of claim 8, wherein the communications hub and the local transmitter are disposed in electrical communication via wired communications.

12. The system of claim 1, wherein each wireless mobile viewing device includes a wireless receiver and does not include a wireless transmitter.

13. The system of claim 1, wherein a wireless mobile viewing device comprises a mobile phone, smartphone, personal digital assistant (PDA), or pocket personal computer.

14. The system of claim 1, wherein a wireless mobile viewing device comprises a handheld consumer electronic device.

15. The system of claim 1, wherein each wireless mobile viewing device includes a transceiver, and wherein each wireless mobile viewing device is configured to register with a wireless network before receiving the video transmitted from the selected video camera.

16. The system of claim 15, wherein the wireless network comprises a cellular network.

17. The system of claim 15, wherein the wireless network comprises a WiFi, WiMax, 802.11(b) compatible, or Bluetooth network.

18. The system of claim 1, wherein some of the plurality of wireless cameras are located on a racecar.

19. The system of claim 1, wherein some of the plurality of wireless cameras are located on the helmet of a football player.

20. The system of claim 1, wherein some of the plurality of wireless cameras are mounted on a physical structure of the venue itself.
